(19) United States
(12) Patent Application Publication
(10) Pub. No.: US 2024/0062380 A1
(43) Pub. Date: Feb. 22, 2024

(54) SCREW HOLE POSITION DETECTING APPARATUS AND DETECTING METHOD

(71) Applicant: GRAND-TEK TECHNOLOGY CO., LTD., New Taipei City (TW)

(72) Inventors: Chien-Hung PAN, New Taipei City (TW); Chun-Chien CHUEH, New Taipei City (TW); Chien-Wen HUNG, New Taipei City (TW)

(21) Appl. No.: 18/091,890

(22) Filed: Dec. 30, 2022

(30) Foreign Application Priority Data
Aug. 16, 2022 (TW) 111130830

(51) Int. Cl. G06T 7/11; G06T 7/90; G06T 7/136

(52) U.S. Cl. CPC G06T 7/11; G06T 7/90; G06T 7/136; G06T 2207/10024

(57) ABSTRACT

A screw hole position detecting apparatus is applied to a board body and at least one screw. The board body defines at least one screw hole. The screw hole position detecting apparatus includes a microprocessor, a lamp group and a camera. The lamp group is configured to illuminate the board body. The camera is configured to photograph the board body to obtain an original image and transmit the original image to the microprocessor. The microprocessor is configured to grayscale convert the original image into a grayscale image, and to convert the grayscale image into a binarization image based on a threshold value. Based on the binarization image, whether the at least one screw hole is locked into the at least one screw is determined.

### BACKGROUND OF THE DISCLOSURE

### Technical Field

The present disclosure relates to a detecting apparatus and a detecting method, and especially relates to a screw hole position detecting apparatus and a screw hole position detecting method.

### Description of Related Art

In recent years, the image processing technology has been widely used in the industry to detect the product defects, thereby improving the product quality and the production efficiency. Although the image processing technology has been used in the industry for a period of time, the image processing technology is still not widely used in the complex industrial processes, such as the detections of pits, holes and locked screws. While taking into account some factors such as the light, color, shape, size and strength, such pits, holes and locked screws are not easy to be directly recognized by the human eyes.

However, the current manufacturing factories, such as the antenna manufacturing factories, are always looking to achieve a higher level of automated missing detection. One of the main tasks of the antenna manufacturing factory in the antenna manufacturing process is to correctly lock the screws to the antenna board, so the antenna manufacturing factory hopes to minimize the missing of the locking screw process. The screw is designed to be fastened to the position in the hole, so as to realize the high precision, safety and stability of the antenna product. Therefore, detecting whether the screws are correctly locked is very important for the manufacture of the antenna board.

Currently, the related art edge detection technology uses a threshold value to assist the defect detection in the grayscale images. There are several important points here: first, Dilation and Erosion are used to expand and shrink the shapes respectively; second, the morphological opening is accomplished by eroding the distorted image, which can be used to remove small objects in the image to preserve the shape and larger objects; third, the morphological closing is accomplished by dilating the eroded image, filling the small gaps in the image to preserve the shape and objects; fourth, the noises and the high frequency effects of the edges are removed by the blurring technique to smooth the image.

For the related art edge detection technologies, the techniques of Sobel, Kirsch, Prewitt and Canny use two masks to convolve a grayscale image to obtain vertical and horizontal directions. However, if the color of the antenna board is similar to the color of the screw head (for example, both are silver), distinguishing whether there is a locked screw in the screw hole is difficult; this is because when using the techniques of Sobel, Kirsch, Prewitt and Canny mentioned above, similar pixels between the screw and the antenna board become insensitive through the masks, resulting in incorrect related art edge detection technologies.

### SUMMARY OF THE DISCLOSURE

In order to solve the above-mentioned problems, an object of the present disclosure is to provide a screw hole position detecting apparatus.

In order to solve the above-mentioned problems, another object of the present disclosure is to provide a screw hole position detecting method.

In order to achieve the object of the present disclosure mentioned above, the screw hole position detecting apparatus of the present disclosure is applied to a board body and at least one screw. The board body defines at least one screw hole. The screw hole position detecting apparatus includes a microprocessor, a lamp group and a camera. The lamp group is electrically connected to the microprocessor. The camera is electrically connected to the microprocessor. Moreover, the lamp group is configured to illuminate the board body. The camera is configured to photograph the board body to obtain an original image and transmit the original image to the microprocessor. The microprocessor is configured to grayscale convert the original image into a grayscale image, and to convert the grayscale image into a binarization image based on a threshold value. Based on the binarization image, whether the at least one screw hole is locked into the at least one screw is determined; namely, the binarization image is checked to determine whether the at least one screw hole is locked into the at least one screw.

Moreover, in an embodiment of the screw hole position detecting apparatus of the present disclosure mentioned above, the lamp group includes a first lamp electrically connected to the microprocessor, a second lamp electrically connected to the microprocessor, a third lamp electrically connected to the microprocessor and a fourth lamp electrically connected to the microprocessor. Moreover, the first lamp is configured to face a first side of the board body to laterally illuminate the first side and the board body. The second lamp is configured to face a second side of the board body to laterally illuminate the second side and the board body. The third lamp is configured to face a third side of the board body to laterally illuminate the third side and the board body. The fourth lamp is configured to face a fourth side of the board body to laterally illuminate the fourth side and the board body.

Moreover, in an embodiment of the screw hole position detecting apparatus of the present disclosure mentioned above, the microprocessor is configured to locate the board body based on a plurality of positioning points of the board body to find the at least one screw hole.

Moreover, in an embodiment of the screw hole position detecting apparatus of the present disclosure mentioned above, the threshold value is a screw grayscale value of a color of the at least one screw; the grayscale image includes a plurality of pixels; the pixels include a plurality of pixel grayscale values; when converting the grayscale image into the binarization image based on the threshold value, the pixels including the pixel grayscale values greater than or equal to the screw grayscale value is converted into a first color of the binarization image, while the pixels including the pixel grayscale values less than the screw grayscale value is converted into a second color of the binarization image.

Moreover, in an embodiment of the screw hole position detecting apparatus of the present disclosure mentioned above, the first color is black; the second color is white.

In order to achieve the another object of the present disclosure mentioned above, the screw hole position detecting method of the present disclosure includes following steps: A lamp group illuminates a board body. A camera photographs the board body to obtain an original image. The camera transmits the original image to a microprocessor. The microprocessor grayscale converts the original image into a grayscale image. The microprocessor converts the grayscale image into a binarization image based on a threshold value. Based on the binarization image, whether at least one screw hole defined by the board body is locked into at least one screw is determined; namely, the binarization image is checked to determine whether at least one screw hole defined by the board body is locked into at least one screw.

Moreover, in an embodiment of the screw hole position detecting method of the present disclosure mentioned above, the screw hole position detecting method further includes following steps: A first lamp of the lamp group faces a first side of the board body to laterally illuminate the first side and the board body. A second lamp of the lamp group faces a second side of the board body to laterally illuminate the second side and the board body. A third lamp of the lamp group faces a third side of the board body to laterally illuminate the third side and the board body. A fourth lamp of the lamp group faces a fourth side of the board body to laterally illuminate the fourth side and the board body.

Moreover, in an embodiment of the screw hole position detecting method of the present disclosure mentioned above, the screw hole position detecting method further includes following steps: Based on a plurality of positioning points of the board body, the microprocessor locates the board body to find the at least one screw hole.

Moreover, in an embodiment of the screw hole position detecting method of the present disclosure mentioned above, the threshold value is a screw grayscale value of a color of the at least one screw; the grayscale image includes a plurality of pixels; the pixels include a plurality of pixel grayscale values; when the microprocessor converts the grayscale image into the binarization image based on the threshold value, the pixels including the pixel grayscale values greater than or equal to the screw grayscale value is converted into a first color of the binarization image, while the pixels including the pixel grayscale values less than the screw grayscale value is converted into a second color of the binarization image.

Moreover, in an embodiment of the screw hole position detecting method of the present disclosure mentioned above, the first color is black; the second color is white. The advantage of the present disclosure is to detect whether the screw hole of the board body is locked into the screw.

Please refer to the detailed descriptions and figures of the present disclosure mentioned below for further understanding the technology, method and effect of the present disclosure achieving the predetermined purposes. It believes that the purposes, characteristic and features of the present disclosure can be understood deeply and specifically. However, the figures are only for references and descriptions, but the present disclosure is not limited by the figures.

### BRIEF DESCRIPTION OF THE DRAWINGS

FIG. 1 shows a block diagram of the first embodiment of the screw hole position detecting apparatus of the present disclosure.

FIG. 2 shows a block diagram of the second embodiment of the screw hole position detecting apparatus of the present disclosure.

FIG. 3 shows an appearance drawing of the screw hole position detecting apparatus of the present disclosure.

FIG. 4 shows a top view of the first lamp to the fourth lamp surrounding the board body of the present disclosure.

FIG. 5 shows a top view of the positioning points on the board body of the present disclosure.

FIG. 6 shows a schematic diagram of a grayscale image including a plurality of pixels according to the present disclosure.

FIG. 7 shows a schematic diagram of an embodiment of the binarization image according to the present disclosure.

FIG. 8 shows a flow chart of the screw hole position detecting method of the present disclosure.

### DETAILED DESCRIPTION

In the present disclosure, numerous specific details are provided, to provide a thorough understanding of embodiments of the disclosure. Persons of ordinary skill in the art will recognize, however, that the present disclosure can be practiced without one or more of the specific details. In other instances, well-known details are not shown or described to avoid obscuring aspects of the present disclosure. Now please refer to the figures for the explanation of the technical content and the detailed description of the present disclosure:

In order to solve the above problem of incorrect edge detection technology, the present disclosure utilizes the exposure principle, and amplifies the intensity energy transmitted by the illumination to distinguish the screw hole and the antenna board. The simulation results show that with the exposure method proposed in the present disclosure, the defect detection result is closer to the screw hole in the original image. Therefore, the present disclosure improving and optimizing the equations to distinguish between locked and non-locked screws is valid and feasible.

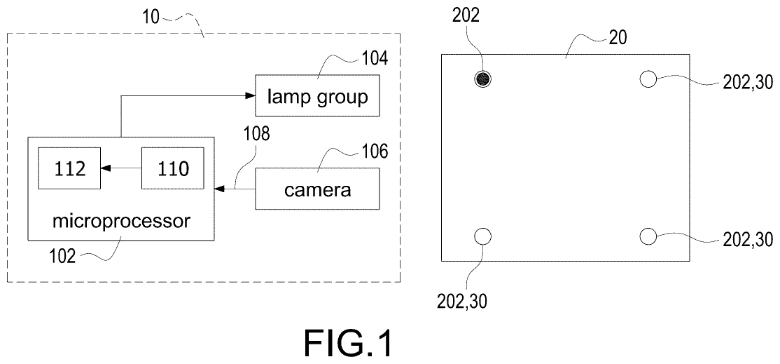

FIG. 1 shows a block diagram of the first embodiment of the screw hole position detecting apparatus of the present disclosure. A screw hole position detecting apparatus 10 of the present disclosure includes a microprocessor 102, a lamp group 104 and a camera 106. The microprocessor 102 is electrically connected to the lamp group 104 and the camera 106. The screw hole position detecting apparatus 10 is applied to a board body 20 (for example, an antenna board) and at least one screw 30. The board body 20 defines at least one screw hole 202. In FIG. 1, the board body 20 defines four screw holes 202. The black screw hole 202 in the upper left corner represents that the screw 30 is not locked (because the screw hole 202 is black and dull inside), and the other three white screw holes 202 represent that the screws 30 are locked (because the head of the screw 30 is silver). The purpose of the present disclosure is to find the screw hole 202 where the screw 30 is not locked in the upper left corner of FIG. 1.

First, the lamp group 104 is configured to illuminate the board body 20; then, the camera 106 is configured to photograph the board body 20 to obtain an original image 108 (which is a color image) and transmit the original image 108 to the microprocessor 102; then, the microprocessor 102 is configured to grayscale convert the original image 108 into a grayscale image 110, and convert the grayscale image 110 into a binarization image 112 based on a threshold value (which is described in details later); finally, based on the binarization image 112, whether the at least one screw hole 202 is locked into the at least one screw 30 is determined (which is described in details later). In an embodiment of the present disclosure but not limiting the present disclosure, the image processing of the present disclosure uses an industrial camera CVG-500M-15RT (as the camera 106) and NVIDIA Jetson Nano development kit (which is arranged to be installed in the microprocessor 102, or used as the microprocessor 102).

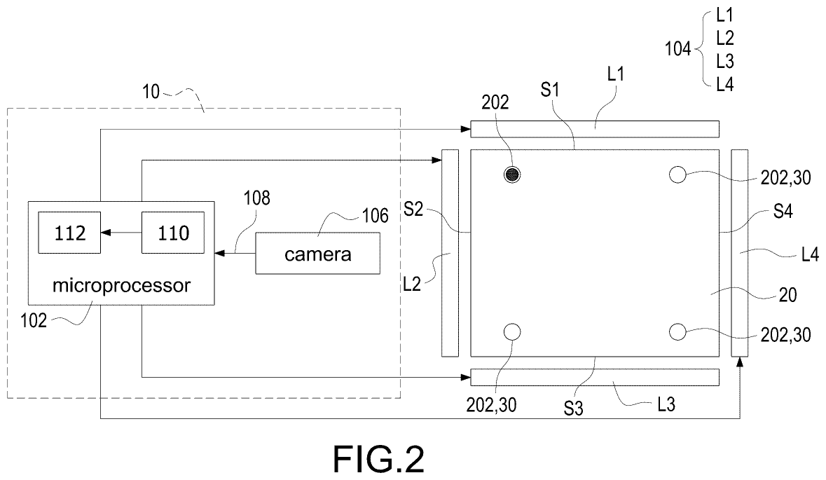

FIG. 2 shows a block diagram of the second embodiment of the screw hole position detecting apparatus of the present disclosure. The descriptions of the elements shown in FIG. 2 which are the same as the elements shown in FIG. 1 are not repeated here for brevity. The lamp group 104 includes a first lamp L1, a second lamp L2, a third lamp L3 and a fourth lamp L4. The first lamp L1, the second lamp L2, the third lamp L3 and the fourth lamp L4 are electrically connected to the microprocessor 102.

The first lamp L1 is configured to face a first side S1 of the board body 20 to laterally illuminate the first side S1 and the board body 20. The second lamp L2 is configured to face a second side S2 of the board body 20 to laterally illuminate the second side S2 and the board body 20. The third lamp L3 is configured to face a third side S3 of the board body 20 to laterally illuminate the third side S3 and the board body 20. The fourth lamp L4 is configured to face a fourth side S4 of the board body 20 to laterally illuminate the fourth side S4 and the board body 20.

In other words, in an embodiment of the present disclosure, the lamp group 104 has to illuminate the board body 20 uniformly and laterally. Since the board body 20 shown in FIG. 2 has four sides, the lamp group 104 has to include four lamps, and the four lamps are respectively arranged on the four sides of the board body 20 so as to uniformly and laterally illuminate the board body 20. In another embodiment of the present disclosure, the lamp group 104 may also be replaced by a ring type lamp, so as to illuminate the board body 20 uniformly and laterally.

The reason for illuminating the board body 20 laterally mentioned above is to make the screw holes 202 which are not locked into the screw 30 appear dark (so that the screw holes 202 which are not locked into the screw 30 are detected by the subsequent image processing). Vertically illuminating the board body 20 causes both the screw holes 202 without the locked screw 30 and the screw holes 202 with the locked screws 30 to appear bright (because the screw holes 202 without the locked screw 30 are illuminated and bright, while the screw holes 202 with the locked screws 30 are bright as well, so that the subsequent image processing cannot distinguish the screw holes 202 without the screw 30 and the screw holes 202 with the screws 30).

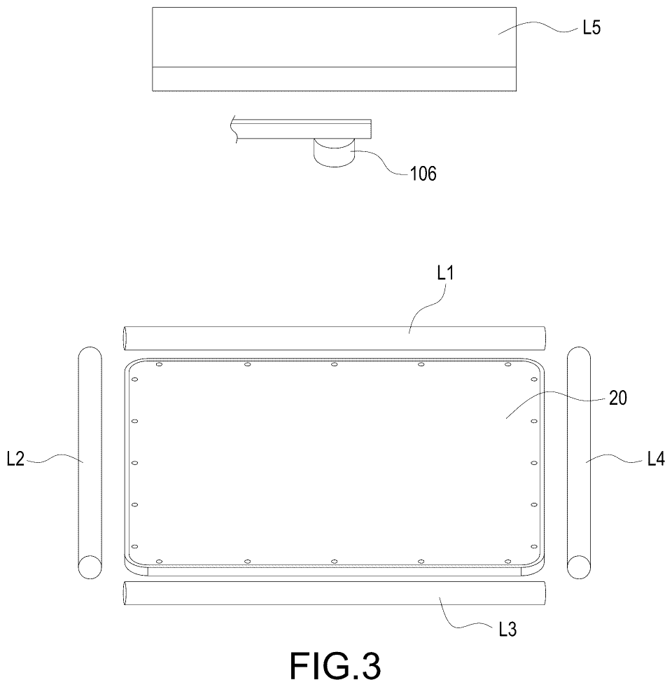

FIG. 3 shows an appearance drawing of the screw hole position detecting apparatus of the present disclosure. In an embodiment of the present disclosure but not limiting the present disclosure, the lamp group 104 further includes a fifth lamp L5 electrically connected to the microprocessor 102 and arranged above the camera 106, so that the board body 20 is slightly illuminated by the fifth lamp L5, but the screw holes 202 which are not locked into the screw 30 are not too bright to be recognized by the image processing.

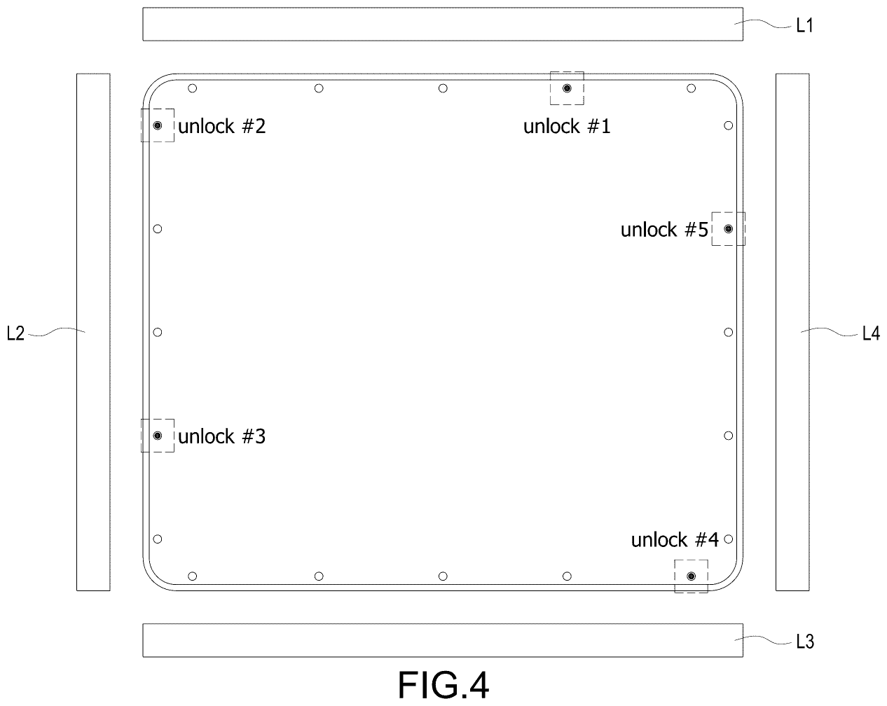

FIG. 4 shows a top view of the first lamp L1 to the fourth lamp L4 surrounding the board body 20 of the present disclosure. In the embodiment of FIG. 4, the board body 20 has five screw holes (unlock#1·unlock#5) which are not locked into the screw.

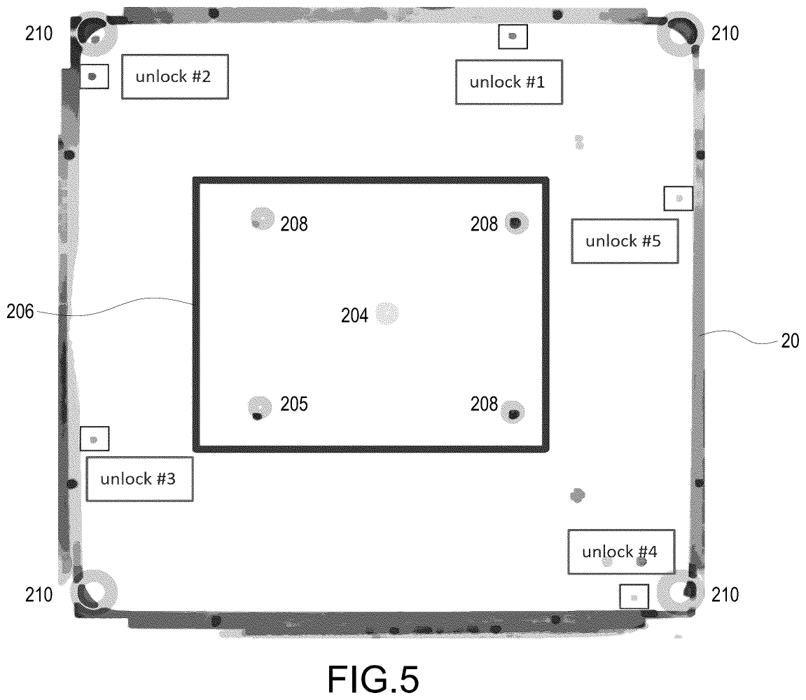

FIG. 5 shows a top view of the positioning points on the board body 20 of the present disclosure. Please refer to FIG. 1 and FIG. 4 at the same time. The microprocessor 102 is configured to locate the board body 20 based on a plurality of positioning points of the board body 20 to find the at least one screw hole 202, which is described in details below: Moreover, first the microprocessor 102 is configured to find a central positioning point 204 on the board body 20 to locate a rectangle 206. Then, the microprocessor 102 is configured to find four inner positioning points 208 on the rectangle 206 to locate the board bod 20. Finally, the microprocessor 102 is configured to find four outer positioning points 210 at four corners of the board body 20 to locate edges of the board body 20. With the above-mentioned positioning procedures, the microprocessor 102 can locate the positions of the screw holes 202.

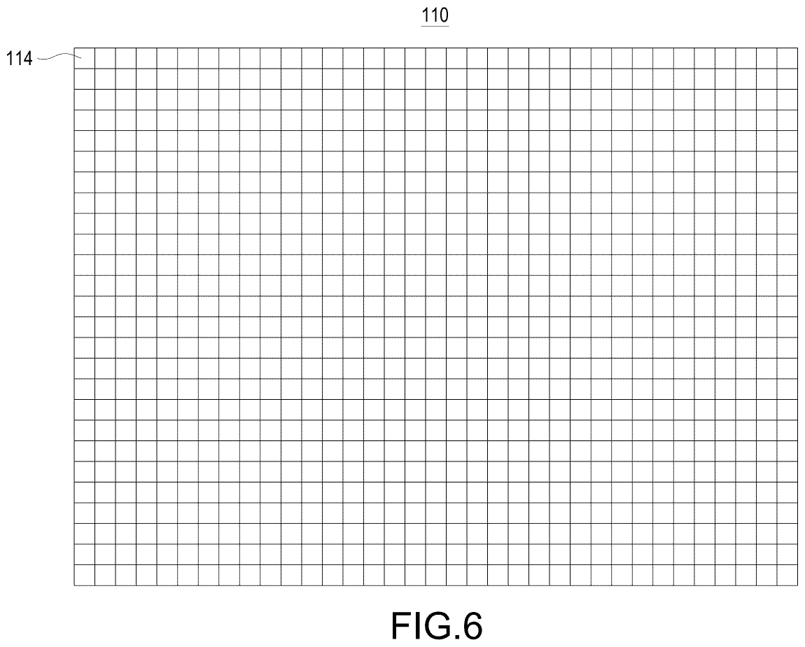

FIG. 6 shows a schematic diagram of a grayscale image 110 including a plurality of pixels 114 according to the present disclosure. FIG. 6 mainly illustrates that the grayscale image 110 may be divided into the pixels 114, while the pixels 114 include a plurality of pixel grayscale values.

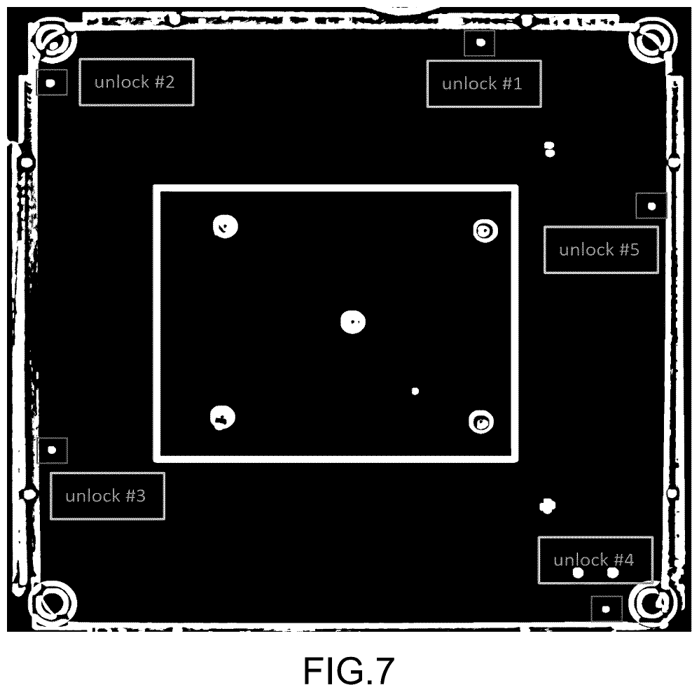

FIG. 7 shows a schematic diagram of an embodiment of the binarization image 112 according to the present disclosure. Please refer to FIG. 1 and FIG. 6 at the same time. The threshold value mentioned above is, for example but not limited to, a screw grayscale value of the color (for example, silver) of the at least one screw 30. When converting the grayscale image 110 into the binarization image 112 based on the threshold value, the pixels 114 including the pixel grayscale values greater than or equal to the screw grayscale value is converted into a first color (for example, black in FIG. 7, which means the board body 20 itself and/or the screw holes which are locked into the screws) of the binarization image 112, while the pixels 114 including the pixel grayscale values less than the screw grayscale value is converted into a second color (for example, white in FIG. 7, which means including the screw holes which are not locked into the screw) of the binarization image 112. Therefore, the operator or the microprocessor 102 can identify the screw holes into which no screw is locked, namely, the screw holes (unlock#1·unlock#5) in FIG. 7. The first color mentioned above may be white while the second color may be black; but according to the product manufacturing experience, it is easier to visually identify the problems by the white characters on the black background.

In addition to using the screw grayscale value of the color of the at least one screw 30 as the threshold value, the grayscale value of the color of the board body 20 itself may also be used as the threshold value (if the color of the board body 20 itself is also silver). Moreover, the threshold value may also be derived by the microprocessor 102 using the following equations, which are described in details below:

The exposure principle is utilized to distinguish the screw hole (without lighting) and the lighted antenna board (including the screw cap) as amplification of the intensity energy transmitted by the illumination on the original image (or calls the original pixel as η_{org}) which utilizes the light transmission power P_{T}_{ₖ}(θ₇₆) with light transmission angle θ_{ι}∈0° ˜360 ° 20 which can be modified as the exposure pixel η_{ι}:

η_{ι}=┌η_{org}·P_{T}_{ⱼ}(θ_{ι})┐, η_{ι}=L if η₇₆ ≥L

Equation 1 expresses that the screw cap (indicating the locked screw) has similar white color compared to the plane of the antenna board via highlights and thus the exposure principle can distinguish the screw hole with black (without highlights) and the screw cap with white, respectively. In Equation 1, the pixels of a given image have L grayscales of [1, 2, . . . , L], wherein η_{ι}is the number of pixels appearing at the ι level in the image; the total number of pixels is N=η₁+η₂+. . . +η_{L} and ┌·┐ is an upper bound. The probability distribution of the normalized grayscale histogram is:

$$P ( i ) = \frac{{n}_{i}}{N} and P ( i ) \geq 0 , {\sum }_{i = 1}^{L} P ( i ) = 1. \qquad ( Equation 2 )$$

Pixels are divided into the background C_{bg} (the screw hole) and the foreground C_{fg} (or called the object, namely the board body); the level of the background C_{bg} is [1, 2, . . . , T*]; the level of the foreground C_{fg} is [T*+1, 2, . . . , L]; the probability of the event happening is:

$${w}_{bg} = {P}_{rob} ( {C}_{bg} ) = {\sum }_{i = 0}^{{T}^{*}} P ( i ) , while \qquad ( Equation 3 )$$

$${w}_{fg} = {P}_{rob} ( {C}_{fg} ) = {\sum }_{i = {T}^{*} + 1}^{L - 1} P ( i ) .$$

The group average level u_{bg} of the background and the group average level u_{fg} of the foreground are respectively:

$${u}_{b g} = {\sum }_{i = 0}^{{T}^{*}} \frac{P ( i )}{{w}_{b g}} * i and {u}_{f g} = {\sum }_{i = {T}^{*} + 1}^{L - 1} \frac{P ( i )}{{w}_{f g}} * i . \qquad ( Equation 4 )$$

The threshold value is used to distinguish the colors of the background and the foreground to detect the position where the screw is locked or not, so the optimization problem of the mean principle may be written as:

$${T}_{o p t}^{*} = {min}_{{θ}_{h , i} , {P}_{{T}_{j}}} {‖ {u}_{f g} ( {θ}_{h , i} , {P}_{{T}_{j}} ) - {u}_{b g} ( {θ}_{h , i} , {P}_{{T}_{j}} ) ‖}_{2}^{2} . \qquad ( Equation 5 )$$

In order to describe the optimization of Equation 5, the group variance σ_{bg}² of the background and the group variance σ_{fg}² of the foreground are respectively:

$${σ}_{b g}^{2} = {\sum }_{i = 0}^{{T}^{*}} {( i - {u}_{b g} )}^{2} \frac{P ( i )}{{w}_{b g}} and \qquad ( Equation 6 )$$

$${σ}_{f g}^{2} = {\sum }_{i = {T}^{*} + 1}^{L - 1} {( i - {u}_{f g} )}^{2} \frac{P ( i )}{{w}_{f g}} .$$

The optimization problem of Equation 5 obtaining the optimization threshold value T* may be simplified as the maximization of

$${σ}_{b g}^{2} ( T ) : {T}^{*} = {max}_{{θ}_{i} , {P}_{{T}_{j}}} {σ}_{b g}^{2} ( T ) . \qquad ( Equation 7 )$$

Moreover, the calculation of σ_{bg}² (T) may be derived as the following operations:

$${σ}_{{T}^{*}}^{2} = {\sum }_{i = 0}^{L - 1} {( i - {u}_{{T}^{*}} )}^{2} P ( i ) = {\sum }_{i = 0}^{{T}^{*}} {( i - {u}_{{T}^{*}} )}^{2} P ( i ) + {\sum }_{i = {T}^{*} + 1}^{L - 1} {( i - {u}_{{T}^{*}} )}^{2} P ( i ) = {w}_{b g} {σ}_{b g}^{2} + {w}_{f g} {σ}_{f g}^{2} + {( {u}_{b g} - {u}_{{T}^{*}} )}^{2} {w}_{b g} + {( {u}_{f g} - {u}_{{T}^{*}} )}^{2} {w}_{f g} = {σ}_{b g}^{2} + {σ}_{f g}^{2} . \qquad ( Equation 8 )$$

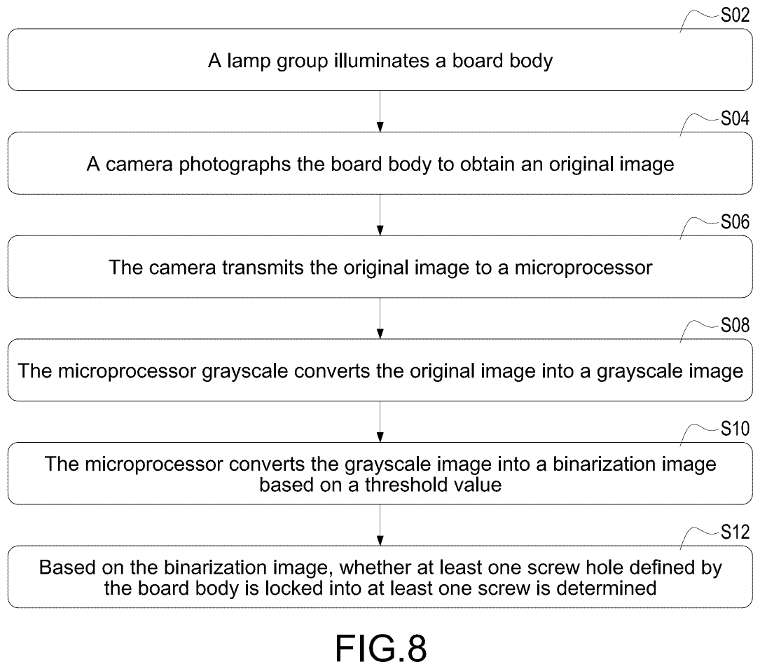

FIG. 8 shows a flow chart of the screw hole position detecting method of the present disclosure. A screw hole position detecting method of the present disclosure includes following steps:

Step S02: A lamp group illuminates a board body. Then, the screw hole position detecting method goes to the step S04.

Step S04: A camera photographs the board body to obtain an original image. Then, the screw hole position detecting method goes to the step S06.

Step S06: The camera transmits the original image to a microprocessor. Then, the screw hole position detecting method goes to the step S08.

Step S08: The microprocessor grayscale converts the original image into a grayscale image. Then, the screw hole position detecting method goes to the step S10.

Step S10: The microprocessor converts the grayscale image into a binarization image based on a threshold value. Then, the screw hole position detecting method goes to the step S12.

Step S12: Based on the binarization image, whether at least one screw hole defined by the board body is locked into at least one screw is determined.

The screw hole position detecting method further includes following steps: A first lamp of the lamp group faces a first side of the board body to laterally illuminate the first side and the board body. A second lamp of the lamp group faces a second side of the board body to laterally illuminate the second side and the board body. A third lamp of the lamp group faces a third side of the board body to laterally illuminate the third side and the board body. A fourth lamp of the lamp group faces a fourth side of the board body to laterally illuminate the fourth side and the board body. Based on a plurality of positioning points of the board body, the microprocessor locates the board body to find the at least one screw hole.

Moreover, the threshold value is a screw grayscale value of a color of the at least one screw; the grayscale image includes a plurality of pixels; the pixels include a plurality of pixel grayscale values; when the microprocessor converts the grayscale image into the binarization image based on the threshold value, the pixels including the pixel grayscale values greater than or equal to the screw grayscale value is converted into a first color (for example, black) of the binarization image, while the pixels including the pixel grayscale values less than the screw grayscale value is converted into a second color (for example, white) of the binarization image.

The present disclosure uses the exposure principle to distinguish whether the screw hole is locked into the screw or not locked into the screw. The advantage of the present disclosure is to detect whether the screw hole of the board body is locked into the screw.

Although the present disclosure has been described with reference to the embodiment thereof, it will be understood that the disclosure is not limited to the details thereof. Various substitutions and modifications have been suggested in the foregoing description, and others will occur to those of ordinary skill in the art. Therefore, all such substitutions and modifications are intended to be embraced within the scope of the disclosure as defined in the appended claims.

What is claimed is:

1. A screw hole position detecting apparatus applied to a board body and at least one screw, the board body defining at least one screw hole, the screw hole position detecting apparatus comprising:
a microprocessor;
a lamp group electrically connected to the microprocessor; and
a camera electrically connected to the microprocessor,
wherein the lamp group is configured to illuminate the board body; the camera is configured to photograph the board body to obtain an original image and transmit the original image to the microprocessor; the microprocessor is configured to grayscale convert the original image into a grayscale image, and to convert the grayscale image into a binarization image based on a threshold value; based on the binarization image, whether the at least one screw hole is locked into the at least one screw is determined.

2. The screw hole position detecting apparatus of claim 1, wherein the lamp group comprises:
a first lamp electrically connected to the microprocessor;
a second lamp electrically connected to the microprocessor;
a third lamp electrically connected to the microprocessor; and
a fourth lamp electrically connected to the microprocessor,
wherein the first lamp is configured to face a first side of the board body to laterally illuminate the first side and the board body; the second lamp is configured to face a second side of the board body to laterally illuminate the second side and the board body; the third lamp is configured to face a third side of the board body to laterally illuminate the third side and the board body; the fourth lamp is configured to face a fourth side of the board body to laterally illuminate the fourth side and the board body.

3. The screw hole position detecting apparatus of claim 2, wherein the microprocessor is configured to locate the board body based on a plurality of positioning points of the board body to find the at least one screw hole.

4. The screw hole position detecting apparatus of claim 3, wherein the threshold value is a screw grayscale value of a color of the at least one screw; the grayscale image comprises a plurality of pixels; the pixels comprise a plurality of pixel grayscale values; when converting the grayscale image into the binarization image based on the threshold value, the pixels comprising the pixel grayscale values greater than or equal to the screw grayscale value is converted into a first color of the binarization image, while the pixels comprising the pixel grayscale values less than the screw grayscale value is converted into a second color of the binarization image.

5. The screw hole position detecting apparatus of claim 4, wherein the first color is black; the second color is white.

6. A screw hole position detecting method comprising:
illuminating a board body by a lamp group;
photographing the board body to obtain an original image by a camera;
transmitting the original image to a microprocessor by the camera;
grayscale converting the original image into a grayscale image by the microprocessor;
converting the grayscale image into a binarization image based on a threshold value by the microprocessor; and
determining whether at least one screw hole defined by the board body is locked into at least one screw based on the binarization image.

7. The screw hole position detecting method of claim 6, further comprising:
facing a first side of the board body to laterally illuminate the first side and the board body by a first lamp of the lamp group;
facing a second side of the board body to laterally illuminate the second side and the board body by a second lamp of the lamp group;
facing a third side of the board body to laterally illuminate the third side and the board body by a third lamp of the lamp group; and
facing a fourth side of the board body to laterally illuminate the fourth side and the board body by a fourth lamp of the lamp group.

8. The screw hole position detecting method of claim 7, further comprising:
locating the board body to find the at least one screw hole based on a plurality of positioning points of the board body by the microprocessor.

9. The screw hole position detecting method of claim 8, wherein the threshold value is a screw grayscale value of a color of the at least one screw; the grayscale image comprises a plurality of pixels; the pixels comprise a plurality of pixel grayscale values; when the microprocessor converts the grayscale image into the binarization image based on the threshold value, the pixels comprising the pixel grayscale values greater than or equal to the screw grayscale value is converted into a first color of the binarization image, while the pixels comprising the pixel grayscale values less than the screw grayscale value is converted into a second color of the binarization image.

10. The screw hole position detecting method of claim 9, wherein the first color is black; the second color is white.
